(19) United States
(12) Patent Application Publication
(10) Pub. No.: US 2026/0302814 A1
(43) Pub. Date: Oct. 1, 2026

(54) ANOMALY DETECTION SYSTEM, ANOMALY DETECTION METHOD, AND RECORDING MEDIUM

(71) Applicant: Panasonic Automotive Systems Co., Ltd., Kanagawa (JP)

(72) Inventors: Tomohisa SEZAKI, Kanagawa (JP); Takumaru NAGAI, Osaka (JP); Akihito TAKEUCHI, Osaka (JP)

(73) Assignee: Panasonic Automotive Systems Co., Ltd., Kanagawa (JP)

(21) Appl. No.: 19/445,090

(22) Filed: Jan. 9, 2026

(30) Foreign Application Priority Data
Mar. 27, 2025 (JP) 2025-054306

(51) Int. Cl. H02J 7/80; B60L 53/60; B60L 55/00; H02J 7/60

(52) U.S. Cl. CPC H02J 7/80; B60L 53/60; B60L 55/00; H02J 7/60; B60L 2240/62

(57) ABSTRACT

An anomaly detection system detects an anomaly of a bidirectional charging infrastructure system that includes a bidirectional charging station. The anomaly detection system includes: an obtainer that obtains position information of an electric vehicle parked at the bidirectional charging station and bidirectional charging information related to the bidirectional charging station and the electric vehicle; and a determiner that determines whether an anomaly is present in the bidirectional charging infrastructure system, based on the position information and the bidirectional charging information.

### CROSS REFERENCE TO RELATED APPLICATION

The present application is based on and claims priority of Japanese Patent Application No. 2025-054306 filed on Mar. 27, 2025.

### Field

The present disclosure relates to an anomaly detection system, an anomaly detection method, and a recording medium that are for a bidirectional charging infrastructure system for charging and discharging the batteries of electric vehicles.

### BACKGROUND

Patent Literature (PTL) 1 discloses a method for detecting an anomalous operating state of a charging infrastructure system.

The above method includes: obtaining target characteristics of a charging process; determining process parameters for the charging process based on the obtained target characteristics; performing the charging process based on the determined process parameters; determining a performance metric for the performed charging process; generating a data set for the charging process; calculating and storing at least one first set of statistical data based on a data set for a first time interval and at least one second set of statistical data based on a data set for a second time interval; comparing the at least one first set with the at least one second set; and determining, based on a calculated set of difference values, whether the charging infrastructure system is operating in an anomalous operating state.

### CITATION LIST

### Patent Literature

PTL 1: Japanese Patent No. 7339313

### SUMMARY

However, the charging infrastructure system according to PTL 1 can be improved upon.

In view of this, the present disclosure is capable of improving upon the above related art.

An anomaly detection system according to one aspect of the present disclosure is an anomaly detection system that detects an anomaly of a bidirectional charging infrastructure system that includes a bidirectional charging station. The anomaly detection system includes: an obtainer that obtains position information of an electric vehicle parked at the bidirectional charging station, and bidirectional charging information related to the bidirectional charging station and the electric vehicle; and a determiner that determines whether an anomaly is present in the bidirectional charging infrastructure system, based on the position information and the bidirectional charging information.

The anomaly detection system and the like according to the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure. FIG. 1

FIG. 1 is a block diagram illustrating a bidirectional charging infrastructure system and a vehicle system that includes an anomaly detection system. FIG. 2

FIG. 2 is an explanatory diagram illustrating an anomaly occurring in the bidirectional charging infrastructure system. FIG. 3

FIG. 3 is an explanatory diagram illustrating demand response states in specific areas. FIG. 4

FIG. 4 is a flowchart illustrating an operation example of the anomaly detection system. FIG. 5

FIG. 5 is a flowchart illustrating an operation example of the anomaly detection system in specific areas.

### DESCRIPTION OF EMBODIMENT

Hereinafter, one or more embodiments will be specifically described with reference to the drawings.

Note that each of the one or more embodiments described below shows a general or specific example. The numeral values, shapes, materials, structural elements, arrangement and connection of structural elements, steps, an order of steps, etc., indicated in the following one or more embodiments are mere examples and are not intended to limit the scope of the present disclosure. Moreover, among structural elements described in the following one or more embodiments, those not described in any of the independent claims are described as optional structural elements.

Moreover, the figures are schematic diagrams and are not necessarily precise illustrations. Accordingly, for example, the figures are not necessarily to scale. Moreover, structural elements that are essentially the same share like reference signs in the figures, and overlapping explanations thereof are omitted or simplified.

### Embodiment

### Overview

In recent years, the tight power supply-demand balance caused by disasters has triggered the reevaluation of energy management focused on power supply-demand balance, in addition to the conventional promotion of energy saving. For example, distributed energy resources (DERs) introduced on the consumer side are becoming widespread, including the following: cogeneration systems using solar power generation and household fuel cells; storage batteries; electric vehicles; and negawatts.

As such, conventional energy supply systems that rely on large-scale power plants are being reconsidered, and mechanisms are being established that enable consumer-side energy resources to be utilized for power systems.

Each of distributed energy resources in factories and households is small-scale. However, combining these resources together by internet-of-things (IoT)-based technologies and remotely and integrally controlling the resources enables establishing a mechanism that can be used to balance power supply and demand. This mechanism is called a “virtual power plant (VPP)” because it functions like a single power plant.

In this trend, energy resource aggregation businesses (ERABs) are attracting attention as a new business area as more DERs are introduced to the consumer side.

One ERAB is electric vehicle (EV) parking lots. EV parking lots may adopt demand response (DR), which enables adjusting the charging and discharging of electric vehicles by controlling consumers' energy resources. In DR, a resource aggregator (RA) directly makes VPP service contracts with consumers and controls their energy resources. The RA remotely controls charging and discharging performed at the EV parking lots, thereby enabling regional DR operation for distributed energy resources.

However, with the expansion of DERs, various business operators participate in ERABs. This poses a concern that a security hole may be created somewhere in an increasingly massive grid network in the future. For example, a cyber security attack against a security hole would significantly affect the entire grid network.

A cyber security attack against or a failure in an ERAB infrastructure system may cause a DR operation trouble. The system may then be unable to implement scheduled power supply or power consumption, causing relevant regions to experience a power shortage, large-scale power outage, or power wastage with excessive power supply.

Unfortunately, conventional techniques have failed to sufficiently address troubles such as cyber security attacks and failures.

In view of the above, the present disclosure provides an anomaly detection system and the like that enable detecting and addressing cyber security attacks against and failures in a bidirectional charging infrastructure system.

### Configuration and Functions

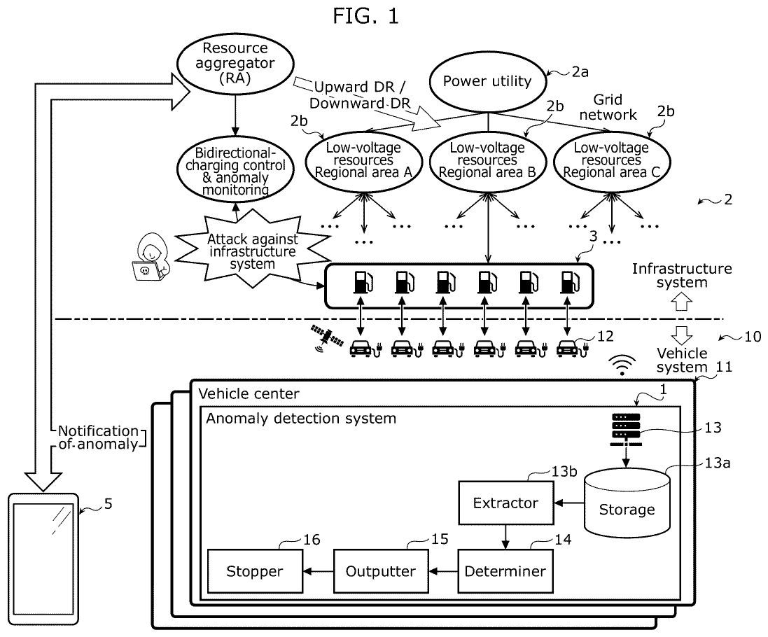

With reference to FIGS. 1 to 3, the configuration and functions of anomaly detection system 1 in this embodiment will be described.

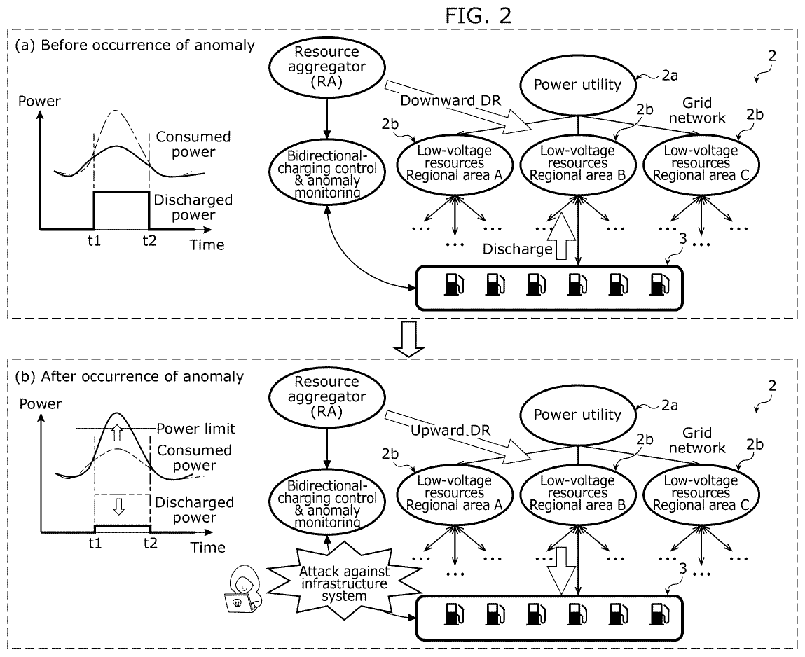

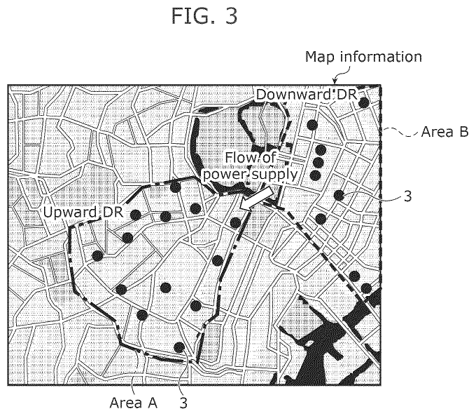

FIG. 1 is a block diagram illustrating bidirectional charging infrastructure system 2 and vehicle system 10 that includes anomaly detection system 1. FIG. 2 is an explanatory diagram illustrating an anomaly occurring in bidirectional charging infrastructure system 2. FIG. 3 is an explanatory diagram illustrating demand response (DR) states in specific areas.

Bidirectional charging infrastructure system 2 includes power utility 2a, and low-voltage resources 2b in regional areas. FIG. 1 shows regional areas A to C.

Power utility 2a is a series of systems, including power generation, transformation, transmission, and distribution systems, for supplying power generated by power plants to consumers' power receiving facilities.

Power utility 2a is connected to low-voltage resources 2b in the regional areas so as to allow power transfer, thereby forming a grid network. A grid network refers to a power transmission utility (a power grid). Low-voltage resources 2b are consumer facilities on the consumer side, including the following: cogeneration systems using solar power generation and household fuel cells; storage batteries; electric vehicles; and negawatts. One of low-voltage resources 2b in this embodiment is bidirectional charging station 3.

The batteries of electric vehicles 12 are connected to bidirectional charging station 3 so as to allow power transfer. Bidirectional charging station 3 is an EV parking lot where the batteries of electric vehicles 12, connected so as to allow power transfer, can be charged and discharged. Bidirectional charging station 3 has EV bidirectional chargers. The EV bidirectional chargers can charge and discharge the batteries of electric vehicles 12, connected so as to allow power transfer, by supplying power to and receiving power from the batteries of electric vehicles 12. In this embodiment, an EV bidirectional charger connected to electric vehicle 12 for power transfer may be expressed as bidirectional charging station 3 connected to electric vehicle 12 for power transfer.

Low-voltage resources 2b in the regional areas are aggregated by a resource aggregator. The resource aggregator is an operator that manages low-voltage resources 2b by collectively controlling their charging and discharging, and monitoring for anomalies. The resource aggregator predicts the amount of power to be generated at each low-voltage resource 2b to sell the power on the wholesale electricity market and trade the power directly with consumers. The resource aggregator also controls the amount of power generated at each low-voltage resource 2b based on the generation schedule of low-voltage resource 2b, thereby achieving a power generation plan and contributing to load balancing in power utility 2a.

Examples of control by the resource aggregator include upward DR and downward DR.

Upward DR refers to increasing the power demand in bidirectional charging infrastructure system 2. For example, upward DR involves operating consumers' power receiving facilities to consume the excess output of renewable energy, or charging the batteries of consumers' power receiving facilities such as electric vehicles 12.

Downward DR refers to inhibiting the power demand in bidirectional charging infrastructure system 2. For example, downward DR involves reducing the output of consumers' power receiving facilities during the peak period of the power demand to balance the supply and demand.

Vehicle system 10 is communicatively connected to above bidirectional charging infrastructure system 2. Vehicle system 10 is separate from and independent of bidirectional charging infrastructure system 2. “Separate from and independent of” means that the components or functions of vehicle system 10 and the components or functions of bidirectional charging infrastructure system 2 are not interdependent and can be independently performed or operated.

Vehicle system 10 includes vehicle center 11 and electric vehicles 12.

Vehicle center 11 can obtain vehicle data on each electric vehicle 12 through communication with electric vehicles 12. The vehicle data includes position information of electric vehicle 12 and bidirectional charging-related information of electric vehicle 12, as well as estimated bidirectional charging information obtained from the user of bidirectional charging station 3.

Vehicle center 11 has anomaly detection system 1.

Anomaly detection system 1 is configured to detect anomalies in bidirectional charging infrastructure system 2, which has bidirectional charging station 3.

Anomaly detection system 1 includes communicator 13, storage 13a, extractor 13b, determiner 14, outputter 15, and stopper 16.

Communicator 13, being capable of communicating with electric vehicles 12 through a communication network, can obtain the position information of electric vehicles 12 from electric vehicles 12. Thus, communicator 13 can obtain the position information of electric vehicles 12 parked at bidirectional charging station 3 and connected to bidirectional charging station 3 for power transfer. Multiple electric vehicles 12 can communicate through the communication network. Communicator 13 can therefore obtain the individual position information of each electric vehicle 12. Communicator 13 may be an example of an obtainer.

For example, communicator 13 can compare map information that includes the registered locations of bidirectional charging stations 3 with the position information of electric vehicle 12. Communicator 13 can thus determine which bidirectional charging station 3 electric vehicle 12 is parked at, and the position of electric vehicle 12 within bidirectional charging station 3. The position information of each electric vehicle 12 can be obtained through a global positioning system (GPS) function installed in electric vehicle 12. The manner of obtaining the position information is not limited to the GPS function. For example, the position information may be obtained from communication path information or in other known manners.

In this embodiment, the position information of electric vehicle 12 is not information on the position of electric vehicle 12 that is travelling. Rather, the position information refers to information indicating the position of electric vehicle 12 parked at bidirectional charging station 3 and connected to bidirectional charging station 3 for power transfer.

Communicator 13 can obtain bidirectional charging information related to bidirectional charging station 3 and electric vehicles 12 through the communication network. The bidirectional charging information includes bidirectional charging-related information and estimated bidirectional charging information.

Specifically, communicator 13 can obtain, from electric vehicles 12 connected to bidirectional charging station 3 so as to allow power transfer, the bidirectional charging-related information of electric vehicles 12 through the communication network. Multiple electric vehicles 12 can communicate through the communication network. Communicator 13 can therefore obtain the individual bidirectional charging-related information of each electric vehicle 12. It is to be noted that communicator 13 may obtain the bidirectional charging-related information of electric vehicles 12 from bidirectional charging station 3.

The bidirectional charging-related information of each electric vehicle 12, connected to bidirectional charging station 3 so as to allow power transfer, includes the following information: bidirectional charging time information, indicating at least one of a charging period or a discharging period; and bidirectional charging energy amount information, indicating at least one of the amount of charged energy or the amount of discharged energy corresponding to the bidirectional charging time information.

For the charging of the battery of electric vehicle 12, the bidirectional charging time information includes a charging start time and a charging end time. For the discharging of the battery of electric vehicle 12, the bidirectional charging time information includes a discharging start time and a discharging end time.

For the charging of the battery of electric vehicle 12, the bidirectional charging energy amount information includes the charging start time and the charging end time, and the amount of charged energy in the period between the charging start time and the charging end time. For the discharging of the battery of electric vehicle 12, the bidirectional charging energy amount information includes the discharging start time and the discharging end time, and the amount of discharged energy in the period between the discharging start time and the discharging end time.

Communicator 13 can obtain the estimated bidirectional charging information from the user of bidirectional charging station 3 corresponding to the position information of each electric vehicle 12. The user of bidirectional charging station 3 may be an ERAB that operates bidirectional charging station 3, or the owner of electric vehicle 12. It is to be noted that the estimated bidirectional charging information may be obtained based on statistical information extracted from the past history of the bidirectional charging-related information, or may be obtained based on information estimated using artificial intelligence.

The estimated bidirectional charging information of each electric vehicle 12, connected to bidirectional charging station 3 corresponding to the position information so as to allow power transfer, includes estimated bidirectional charging time information, indicating at least one of an estimated charging period or an estimated discharging period.

The estimated bidirectional charging time information includes at least one of: an estimated charging start time and an estimated charging end time of estimated charging from bidirectional charging station 3 corresponding to the position information to electric vehicle 12; or an estimated discharging start time and an estimated discharging end time of estimated discharging from the battery of electric vehicle 12 to bidirectional charging station 3.

The estimated bidirectional charging information may further include estimated bidirectional charging energy amount information, indicating at least one of an estimated amount of charged energy or an estimated amount of discharged energy corresponding to the estimated bidirectional charging time information.

The estimated bidirectional charging energy amount information may include at least one of: an estimated amount of charged energy in the period between the estimated charging start time and the estimated charging end time of the estimated charging to the battery of electric vehicle 12; or an estimated amount of discharged energy in the period between the estimated discharging start time and the estimated discharging end time of the estimated discharging from the battery of electric vehicle 12.

Communicator 13 can store, in storage 13a, information on each electric vehicle 12, such as the position information, the bidirectional charging-related information, and the estimated bidirectional charging information. Storage 13a is implemented by, for example, a semiconductor memory.

Extractor 13b can extract information on each electric vehicle 12, such as the position information, the bidirectional charging-related information, and the estimated bidirectional charging information, stored in storage 13a. Extractor 13b can output, to determiner 14, the extracted information such as the position information, the bidirectional charging-related information, and the estimated bidirectional charging information. Extractor 13b may be an example of the obtainer.

Determiner 14 can determine whether an anomaly is present in bidirectional charging infrastructure system 2 based on the position information, the bidirectional charging-related information, and the estimated bidirectional charging information of each electric vehicle 12 obtained by communicator 13.

Specifically, determiner 14 compares the bidirectional charging time information in the bidirectional charging-related information with the estimated bidirectional charging time information in the estimated bidirectional charging information. Determiner 14 may further compare the bidirectional charging energy amount information in the bidirectional charging-related information with the estimated bidirectional charging energy amount information in the estimated bidirectional charging information.

If the comparison indicates that the bidirectional charging time information is substantially the same as the estimated bidirectional charging time information, determiner 14 may determine that no anomaly is present in bidirectional charging infrastructure system 2. Alternatively, if the comparison indicates that the bidirectional charging-related information is substantially the same as the estimated bidirectional charging information, determiner 14 may determine that no anomaly is present in bidirectional charging infrastructure system 2. That is, in the latter case, if the bidirectional charging time information is substantially the same as the estimated bidirectional charging time information and if the bidirectional charging energy amount information is substantially the same as the estimated bidirectional charging energy amount information, determiner 14 may determine that no anomaly is present in bidirectional charging infrastructure system 2.

If the comparison indicates that the bidirectional charging time information is not substantially the same as the estimated bidirectional charging time information, determiner 14 may determine that an anomaly is present in bidirectional charging infrastructure system 2. Alternatively, if the comparison indicates that the bidirectional charging-related information is not substantially the same as the estimated bidirectional charging information, determiner 14 may determine that an anomaly is present in bidirectional charging infrastructure system 2. That is, in the latter case, if the bidirectional charging time information is not substantially the same as the estimated bidirectional charging time information and if the bidirectional charging energy amount information is not substantially the same as the estimated bidirectional charging energy amount information, determiner 14 may determine that an anomaly is present in bidirectional charging infrastructure system 2.

Anomalies in bidirectional charging infrastructure system 2 include the occurrence of a cyber security attack against bidirectional charging infrastructure system 2, and the occurrence of a failure in bidirectional charging infrastructure system 2.

For example, as shown in (a) of FIG. 2, during the period between discharging start time t1 and discharging end time t2, the resource aggregator may reduce the power supplied from power utility 2a to the low-voltage resource 2b side. In this case, the resource aggregator causes charging at bidirectional charging station 3, located in regional area B having low-voltage resources 2b, to stop, and causes the batteries of electric vehicles 12, connected to bidirectional charging station 3 so as to allow power transfer, to be discharged (downward DR). Bidirectional charging station 3 accordingly increases discharged power in regional area B (the thick solid line). Thus, although the power consumption in regional area B in the period between discharging start time t1 and discharging end time t2 could increase as indicated by the dashed and double-dotted line, the power supply from power utility 2a to regional area B can be reduced as indicated by the thin solid line.

Now, as shown in (b) of FIG. 2, an anomaly may occur in bidirectional charging infrastructure system 2 and charging at bidirectional charging station 3 may be started. Then, the discharged power at bidirectional charging station 3 decreases from that indicated by the dashed and double-dotted line to that indicated by the thick solid line. The power consumption in regional area B increases and may exceed the power limit, as indicated by the thin solid line. This may lead to tight power supply in regional area B, which includes the utility for bidirectional charging station 3. Consequently, a power shortage may occur in regional area B, as well as other regional areas affected by regional area B.

In this embodiment, this is addressed by outputter 15 and stopper 16 in the following manner.

As shown in FIG. 1, if determiner 14 determines that an anomaly is present in bidirectional charging infrastructure system 2, outputter 15 can output a notification indicating the presence of the anomaly. Moreover, if determiner 14 determines that an anomaly is present in bidirectional charging infrastructure system 2, outputter 15 may output a notification indicating the presence of the anomaly to recipients such as the resource aggregator and a consumer's terminal device 5.

If determiner 14 determines that an anomaly is present in bidirectional charging infrastructure system 2, stopper 16 can cause bidirectional charging infrastructure system 2 to stop charging or discharging. For example, in the above case, stopper 16 can cause bidirectional charging station 3 to stop charging or discharging. In addition, if determiner 14 determines that an anomaly is present in bidirectional charging infrastructure system 2, stopper 16 can output an instruction to cause electric vehicles 12 to stop charging or discharging.

Furthermore, anomaly detection system 1 in this embodiment may determine whether anomalies are present in specific areas shown in FIG. 3.

In this case, as shown in FIG. 3, communicator 13 may obtain map information that includes the position information of multiple electric vehicles 12 parked at bidirectional charging stations 3 located at multiple locations, and also obtain the demand response (DR) states in specific areas. The demand response (DR) states in the specific areas may be included in the bidirectional charging-related information.

Determiner 14 may determine whether the demand response (DR) state in each specific area in the map information is the upward DR state, which involves increasing the power demand in bidirectional charging infrastructure system 2, or the downward DR state, which involves inhibiting the power demand in bidirectional charging infrastructure system 2. That is, determiner 14 may determine whether the demand response (DR) state in each of the specific areas defined in the map information is the upward DR state or the downward DR state.

The specific areas are preset areas on a map represented by the map information.

For example, as shown in FIG. 3, specific area A indicated by a dashed and single-dotted line and specific area B indicated by a dashed line may be defined in the map information.

In this case, determiner 14 may be able to determine whether the demand response (DR) state in specific area A is the upward DR state or the downward DR state based on the position information and the bidirectional charging-related information of electric vehicles 12 in specific area A. In the case illustrated in FIG. 3, determiner 14 determines that the demand response (DR) state in specific area A is the upward DR state.

Determiner 14 may also be able to determine whether the demand response (DR) state in specific area B is the upward DR state or the downward DR state based on the position information and the bidirectional charging-related information of electric vehicles 12 in specific area B. In the case illustrated in FIG. 3, determiner 14 determines that the demand response (DR) state in specific area B is the downward DR state.

The resource aggregator can perform control for supplying the power in specific area B to specific area A.

Thus, determiner 14 can determine whether an anomaly is present in bidirectional charging infrastructure system 2 in each specific area based on the demand response (DR) state in the specific area and the estimated bidirectional charging information that is set for the specific area. That is, determiner 14 can monitor the bidirectional charging state in each specific area.

### Operation Examples

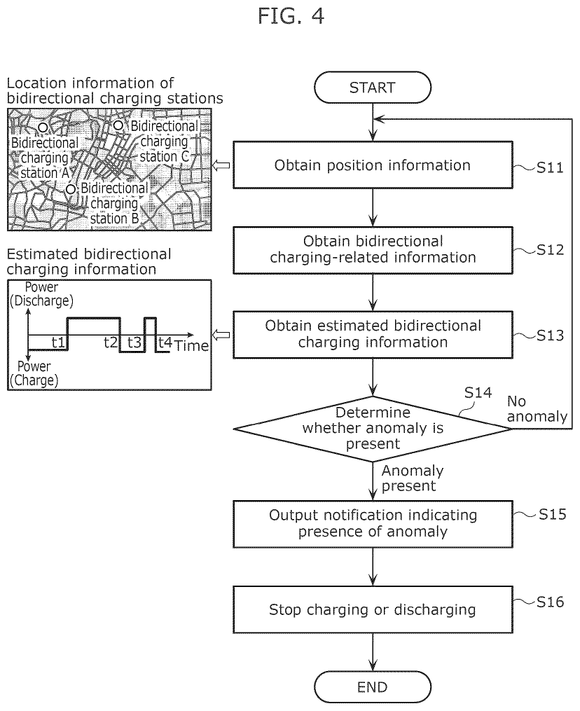

With reference to FIG. 4, an operation example of anomaly detection system 1 in this embodiment will be described.

FIG. 4 is a flowchart illustrating an operation example of anomaly detection system 1.

Communicator 13 obtains the position information of electric vehicle 12 from electric vehicle 12 through the communication network (S11).

Specifically, communicator 13 obtains, through the communication network, location information of bidirectional charging station 3 (location information of one of bidirectional charging stations A to C), and the position information of electric vehicle 12 indicating where electric vehicle 12 is parked within bidirectional charging station 3. It is assumed here that electric vehicle 12 is parked at bidirectional charging station 3. The location information of bidirectional charging station 3, and the position information of electric vehicle 12 indicating where electric vehicle 12 is parked within bidirectional charging station 3, obtained by communicator 13, are stored in storage 13a in association with each other.

Next, from electric vehicle 12, which is connected to bidirectional charging station 3 so as to allow power transfer, communicator 13 obtains the bidirectional charging-related information of electric vehicle 12 through the communication network (S12). The bidirectional charging-related information of electric vehicle 12 is in association with the position information of electric vehicle 12. The bidirectional charging-related information obtained by communicator 13 is stored in storage 13a in association with the position information of electric vehicle 12.

Next, communicator 13 obtains the estimated bidirectional charging information from the user of bidirectional charging station 3 corresponding to the position information of electric vehicle 12 (S13). Extractor 13b extracts information on electric vehicle 12, such as the position information, the bidirectional charging-related information, and the estimated bidirectional charging information, stored in storage 13a.

Next, based on the information on electric vehicle 12 extracted by extractor 13b, such as the position information, the bidirectional charging-related information, and the estimated bidirectional charging information, determiner 14 determines whether an anomaly is present in bidirectional charging infrastructure system 2 (S14).

Specifically, determiner 14 compares the bidirectional charging time information in the bidirectional charging-related information with the estimated bidirectional charging time information in the estimated bidirectional charging information.

In an example, determiner 14 compares the charging start time in the bidirectional charging time information with the estimated charging start time in the estimated bidirectional charging time information to determine whether the start times are substantially the same. Determiner 14 also compares the charging end time in the bidirectional charging time information with the estimated charging end time in the estimated bidirectional charging time information to determine whether the end times are substantially the same.

In another example, determiner 14 compares the discharging start time in the bidirectional charging time information with the estimated discharging start time in the estimated bidirectional charging time information to determine whether the start times are substantially the same. Determiner 14 also compares the discharging end time in the bidirectional charging time information with the estimated discharging end time in the estimated bidirectional charging time information to determine whether the end times are substantially the same.

Determiner 14 may further compare the bidirectional charging energy amount information in the bidirectional charging-related information with the estimated bidirectional charging energy amount information in the estimated bidirectional charging information.

In an example, determiner 14 may compare the amount of energy in the period between the charging start time and the charging end time in the bidirectional charging energy amount information with the estimated amount of energy in the period between the estimated charging start time and the estimated charging end time in the estimated bidirectional charging energy amount information, and determine whether the amounts of energy are substantially the same.

In another example, determiner 14 may compare the amount of energy in the period between the discharging start time and the discharging end time in the bidirectional charging energy amount information with the estimated amount of energy in the period between the estimated discharging start time and the estimated discharging end time in the estimated bidirectional charging energy amount information, and determine whether the amounts of energy are substantially the same.

If the comparison indicates that the bidirectional charging-related information is substantially the same as the estimated bidirectional charging information, determiner 14 determines that no anomaly is present in bidirectional charging infrastructure system 2 (S14: No anomaly). Anomaly detection system 1 then returns the process to step S11.

In contrast, if the comparison indicates that the bidirectional charging time information is not substantially the same as the estimated bidirectional charging time information, determiner 14 determines that an anomaly is present in bidirectional charging infrastructure system 2 (S14: Anomaly present).

Next, outputter 15 outputs a notification indicating the presence of the anomaly to recipients such as stopper 16, vehicle center 11, the resource aggregator, and a consumer's terminal device 5 (S15).

Next, stopper 16 causes bidirectional charging infrastructure system 2 and electric vehicle 12 to stop charging or discharging (S16). Anomaly detection system 1 thus terminates the flowchart in FIG. 4.

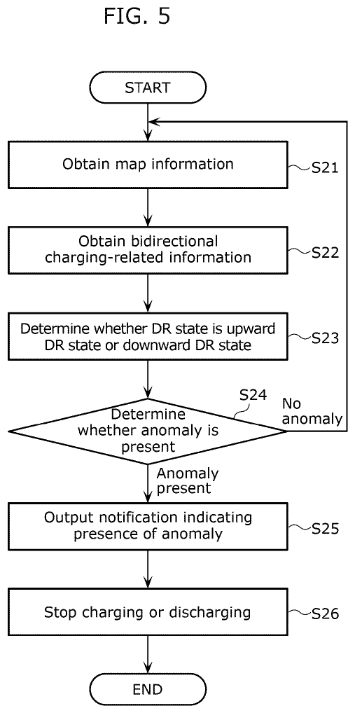

Now, with reference to FIG. 5, an operation example of anomaly detection system 1 in specific areas will be described.

FIG. 5 is a flowchart illustrating an operation example of anomaly detection system 1 in specific areas.

First, communicator 13 obtains, through the communication network and from multiple electric vehicles 12 parked at bidirectional charging stations 3 located at multiple locations, map information that includes the position information of electric vehicles 12 (S21).

Next, from electric vehicles 12, which are connected to bidirectional charging stations 3 at the multiple locations so as to allow power transfer, communicator 13 obtains the bidirectional charging-related information of electric vehicles 12 through the communication network (S22). The bidirectional charging-related information of each electric vehicle 12 is in one-to-one association with the position information of that electric vehicle 12.

Next, based on the map information and the bidirectional charging-related information of electric vehicles 12, determiner 14 determines whether the demand response (DR) state in each specific area defined on a map represented by the map information is the upward DR state or the downward DR state (S23).

Next, based on the demand response (DR) state in each specific area determined at step S23 and the estimated bidirectional charging information that is set for each specific area, determiner 14 determines whether an anomaly is present in bidirectional charging infrastructure system 2 in each specific area (S24).

The upward DR state may include a start time and an end time. The upward DR state may further include the amount of energy in the period between the start time and the end time.

The downward DR state may include a start time and an end time. The downward DR state may further include the amount of energy in the period between the start time and the end time.

For example, determiner 14 compares the demand response (DR) state (upward DR or downward DR) in each specific area with the estimated bidirectional charging information corresponding to the specific area. If the comparison indicates that the demand response (DR) state is substantially the same as the estimated bidirectional charging information, determiner 14 determines that no anomaly is present in the specific area (S24: No anomaly).

Anomaly detection system 1 then returns the process to step S21.

In contrast, if the comparison indicates that the demand response (DR) state in any specific area is not substantially the same as the estimated bidirectional charging information corresponding to the specific area, determiner 14 determines that an anomaly is present in the specific area (S24: Anomaly present).

Next, outputter 15 outputs a notification indicating the presence of the anomaly to recipients such as stopper 16, the resource aggregator, and consumers' terminal devices 5 (S25).

Next, stopper 16 causes bidirectional charging infrastructure system 2 and electric vehicles 12 in each relevant specific area to stop charging or discharging (S26).

Anomaly detection system 1 thus terminates the flowchart in FIG. 5.

### Advantageous Effects

Advantageous effects of anomaly detection system 1 according to this embodiment will be described.

A bidirectional charging infrastructure system, which offers both charging and discharging, may suffer an anomaly, for example a cyber security attack or a failure. The system may then be unable to implement scheduled power supply or power consumption, causing relevant regions to experience a power shortage, large-scale power outage, or power wastage with excessive power supply. Unfortunately, conventional techniques have failed to sufficiently detect and address anomalies, such as cyber security attacks and failures, in a bidirectional charging infrastructure system.

In view of this, as described above, anomaly detection system 1 according to Technique 1 of this embodiment is anomaly detection system 1 that detects an anomaly of bidirectional charging infrastructure system 2 that includes bidirectional charging station 3. Anomaly detection system 1 includes: an obtainer that obtains position information of electric vehicle 12 parked at bidirectional charging station 3, and bidirectional charging information related to bidirectional charging station 3 and electric vehicle 12; and determiner 14 that determines whether an anomaly is present in bidirectional charging infrastructure system 2, based on the position information and the bidirectional charging information.

Thus, whether an anomaly is present in bidirectional charging infrastructure system 2 can be determined based on the position information and the bidirectional charging information, which are obtained from vehicle center 11 that manages electric vehicles 12.

Consequently, anomaly detection system 1 enables detecting and addressing anomalies in bidirectional charging infrastructure system 2.

Moreover, in anomaly detection system 1 according to Technique 2 of this embodiment, the bidirectional charging information includes: bidirectional charging-related information of electric vehicle 12 that is connected to bidirectional charging station 3 to allow power transfer; and estimated bidirectional charging information obtained from a user of bidirectional charging station 3 corresponding to the position information of electric vehicle 12, and determiner 14 determines whether an anomaly is present by comparing the bidirectional charging-related information and the estimated bidirectional charging information.

Thus, whether an anomaly is present in bidirectional charging infrastructure system 2 can be determined more accurately.

Moreover, in anomaly detection system 1 according to Technique 3 in this embodiment, the bidirectional charging-related information includes: bidirectional charging time information indicating at least one of a charging period or a discharging period of electric vehicle 12 at bidirectional charging station 3; and bidirectional charging energy amount information indicating at least one of an amount of charged energy or an amount of discharged energy corresponding to the bidirectional charging time information, and the estimated bidirectional charging information includes: estimated bidirectional charging time information indicating at least one of an estimated charging period or an estimated discharging period at bidirectional charging station 3 corresponding to the position information of electric vehicle 12; and estimated bidirectional charging energy amount information indicating at least one of an estimated amount of charged energy or an estimated amount of discharged energy corresponding to the estimated bidirectional charging time information.

Thus, whether an anomaly is present in bidirectional charging infrastructure system 2 can be determined more accurately.

In addition, a more detailed state of any anomaly present in bidirectional charging infrastructure system 2 can be determined.

Moreover, anomaly detection system 1 according to Technique 4 in this embodiment, further includes: outputter 15 that, when determiner 14 determines that an anomaly is present in bidirectional charging infrastructure system 2, outputs a notification indicating presence of the anomaly.

Thus, outputter 15 can output a notification indicating the presence of the anomaly to recipients such as vehicle center 11, the resource aggregator, and a consumer's terminal device 5. This enables the resource aggregator or other entities to address the anomaly.

Moreover, anomaly detection system 1 according to Technique 5 of this embodiment further includes: stopper 16 that, when determiner 14 determines that an anomaly is present in bidirectional charging infrastructure system 2, causes bidirectional charging infrastructure system 2 to stop charging or discharging.

Thus, if an anomaly is present in bidirectional charging infrastructure system 2, charging or discharging can be stopped.

Moreover, anomaly detection system 1 according to Technique 6 of this embodiment further includes: stopper 16 that, when determiner 14 determines that an anomaly is present in bidirectional charging infrastructure system 2, causes electric vehicle 12 to stop charging or discharging.

Thus, if an anomaly is present in bidirectional charging infrastructure system 2, the system can cause electric vehicle 12 to stop charging or discharging.

Moreover, in anomaly detection system 1 according to Technique 7 of this embodiment, the obtainer obtains map information including position information of a plurality of electric vehicles 12 parked at a plurality of bidirectional charging stations 3, and bidirectional charging-related information of the plurality of electric vehicles 12, the plurality of electric vehicles 12 each being electric vehicle 12, the plurality of bidirectional charging stations 3 each being bidirectional charging station 3, and determiner 14: determines, based on the map information and the bidirectional charging-related information of the plurality of electric vehicles 12, whether a demand response (DR) state in a specific area in the map information is an upward DR state that increases a power demand in bidirectional charging infrastructure system 2 or a downward DR state that inhibits the power demand in bidirectional charging infrastructure system 2; and determines, by using the DR state determined for the specific area, whether an anomaly is present in bidirectional charging infrastructure system 2 in the specific area.

Thus, whether an anomaly is present in bidirectional charging infrastructure system 2 can be determined for each specific area.

Moreover, anomaly detection system 1 according to Technique 8 of this embodiment is separate from and independent of bidirectional charging infrastructure system 2.

Thus, any occurrence of an anomaly in bidirectional charging infrastructure system 2 will not affect anomaly detection system 1, which is in vehicle center 11. This can enhance the security level of anomaly detection system 1.

Moreover, an anomaly detection method according to Technique 9 of this embodiment is an anomaly detection method for detecting an anomaly of bidirectional charging infrastructure system 2 that includes bidirectional charging station 3, the anomaly detection method includes: obtaining, by an obtainer, position information of electric vehicle 12 parked at bidirectional charging station 3 and bidirectional charging information related to bidirectional charging station 3 and electric vehicle 12; and determining, by determiner 14, whether an anomaly is present in bidirectional charging infrastructure system 2, based on the position information and the bidirectional charging information.

This anomaly detection method also provides the same advantageous effects described above.

Moreover, a program according to Technique 10 of this embodiment is a program for causing a computer to execute the anomaly detection method according to Technique 9.

This anomaly detection method also provides the same advantageous effects described above.

### Other Variations

Although the anomaly detection system according to the present disclosure has been described based on the aforementioned embodiment, the present disclosure is not limited to the embodiment. Embodiments obtained by various modifications to any of the embodiments which may be conceived by those skilled in the art may be also included in the scope of the present disclosure so long as they do not depart from the spirit of the present disclosure.

The program in this embodiment may include a computer-executable program for performing the anomaly detection method using an artificial intelligence technology. The artificial intelligence technology may include machine learning models, neural networks, rule-based artificial intelligence (AI), or statistical AI.

Moreover, in the foregoing embodiment, each structural element that is included in the determiner and so on may include dedicated hardware, or may be implemented by executing a software program suitable for the structural element. Each structural element may be implemented by a program executor such as a central processing unit (CPU) or processor reading and executing a software program recorded on a recording medium such as a hard disk or semiconductor memory.

Moreover, each structural element may be implemented by hardware. For example, each structural element may be a circuit (or integrated circuit). These circuits may form a single circuit as a whole, or may be separate circuits. Moreover, each of these circuits may be a general-purpose circuit or a dedicated circuit.

Moreover, the general and specific aspects of the present disclosure may be implemented using a system, a device, a method, an integrated circuit, a computer program, a recording medium such as a compact disc read only memory (CD-ROM). Moreover, these general and specific aspects may be implemented using any combination of systems, devices, methods, integrated circuits, computer programs, and recording media.

Moreover, for example, the present disclosure may be implemented as a method to be executed by a computer, or as a program for causing a computer to execute such a method. Moreover, the present disclosure may be implemented as a non-transitory computer-readable recording medium having recorded thereon such a program.

Note that embodiments obtained by applying various modifications, which occur to those skilled in the art, to the aforementioned embodiment, and embodiments obtained by combining the structural elements and functions in the aforementioned embodiment in any manner within a scope not departing from the spirit of the present disclosure are also included in the present disclosure.

While an exemplary embodiment has been described herein above, it is to be appreciated that various changes in form and detail may be made without departing from the spirit and scope of the present disclosure as presently or hereafter claimed.

### Further Information About Technical Background to This Application

The disclosure of the following patent application including specification, drawings, and claims is incorporated herein by reference in their entirety: Japanese Patent Application No. 2025-054306 filed on Mar. 27, 2025.

### Industrial Applicability

The anomaly detection system and the like according to the present disclosure are applicable to bidirectional charging infrastructure systems and the like.

1. An anomaly detection system that detects an anomaly of a bidirectional charging infrastructure system that includes a bidirectional charging station, the anomaly detection system comprising:
an obtainer that obtains position information of an electric vehicle parked at the bidirectional charging station, and bidirectional charging information related to the bidirectional charging station and the electric vehicle; and
a determiner that determines whether an anomaly is present in the bidirectional charging infrastructure system, based on the position information and the bidirectional charging information.

2. The anomaly detection system according to claim 1, wherein
the bidirectional charging information includes:
bidirectional charging-related information of the electric vehicle that is connected to the bidirectional charging station to allow power transfer; and
estimated bidirectional charging information obtained from a user of the bidirectional charging station corresponding to the position information of the electric vehicle, and
the determiner determines whether an anomaly is present by comparing the bidirectional charging-related information and the estimated bidirectional charging information.

3. The anomaly detection system according to claim 2, wherein
the bidirectional charging-related information includes:
bidirectional charging time information indicating at least one of a charging period or a discharging period of the electric vehicle at the bidirectional charging station; and
bidirectional charging energy amount information indicating at least one of an amount of charged energy or an amount of discharged energy corresponding to the bidirectional charging time information, and
the estimated bidirectional charging information includes:
estimated bidirectional charging time information indicating at least one of an estimated charging period or an estimated discharging period at the bidirectional charging station corresponding to the position information of the electric vehicle; and
estimated bidirectional charging energy amount information indicating at least one of an estimated amount of charged energy or an estimated amount of discharged energy corresponding to the estimated bidirectional charging time information.

4. The anomaly detection system according to claim 1, further comprising:
an outputter that, when the determiner determines that an anomaly is present in the bidirectional charging infrastructure system, outputs a notification indicating presence of the anomaly.

5. The anomaly detection system according to claim 1, further comprising:
a stopper that, when the determiner determines that an anomaly is present in the bidirectional charging infrastructure system, causes the bidirectional charging infrastructure system to stop charging or discharging.

6. The anomaly detection system according to claim 1, further comprising:
a stopper that, when the determiner determines that an anomaly is present in the bidirectional charging infrastructure system, causes the electric vehicle to stop charging or discharging.

7. The anomaly detection system according to claim 2, wherein
the obtainer obtains map information including position information of a plurality of electric vehicles parked at a plurality of bidirectional charging stations, and bidirectional charging-related information of the plurality of electric vehicles, the plurality of electric vehicles each being the electric vehicle, the plurality of bidirectional charging stations each being the bidirectional charging station, and
the determiner:
determines, based on the map information and the bidirectional charging-related information of the plurality of electric vehicles, whether a demand response (DR) state in a specific area in the map information is an upward DR state that increases a power demand in the bidirectional charging infrastructure system or a downward DR state that inhibits the power demand in the bidirectional charging infrastructure system; and
determines, by using the DR state determined for the specific area, whether an anomaly is present in the bidirectional charging infrastructure system in the specific area.

8. The anomaly detection system according to claim 1, wherein
the anomaly detection system is separate from and independent of the bidirectional charging infrastructure system.

9. An anomaly detection method for detecting an anomaly of a bidirectional charging infrastructure system that includes a bidirectional charging station, the anomaly detection method comprising:
obtaining, by an obtainer, position information of an electric vehicle parked at the bidirectional charging station and bidirectional charging information related to the bidirectional charging station and the electric vehicle; and
determining, by a determiner, whether an anomaly is present in the bidirectional charging infrastructure system, based on the position information and the bidirectional charging information.

10. A non-transitory computer-readable recording medium having recorded thereon a program for causing a computer to execute the anomaly detection method according to claim 9.
